(19) United States
(12) Patent Application Publication
(10) Pub. No.: US 2008/0002146 A1
(43) Pub. Date: Jan. 3, 2008

(54) BIOCOMPATIBLE, SURFACE MODIFIED MATERIALS

(76) Inventors: Mark J. Stachowski, Fairport, NY (US); Janelle Uilk, Richmond, VA (US)

Correspondence Address: Glenn D. Smith;Bausch & Lomb Incorporated, One Bausch & Lomb Place, Rochester, NY, 14604, US

(21) Appl. No.: 11/755,314

(22) Filed: May 30, 2007

Related U.S. Application Data
(60) Provisional application No. 60/817,031, filed on Jun. 28, 2006.

(51) Int. Cl. G02C 7/04; B05D 3/00; B32B 7/00; B32B 9/04

(52) U.S. Cl. 351/160 H; 427/2.1; 428/411.1; 428/543; 428/98

(57) ABSTRACT

A biomedical device having a hydrophilic gradient surface is provided, wherein the hydrophilic gradient surface comprises (a) a first layer having a first contact angle; (b) a second layer having a second contact angle less than the first contact angle of the first layer; and (c) a third layer having a third contact angle less than the first and second contact angles of the first and second layers. A method for increasing hydrophilicity or wettability of a biomedical device having a hydrophilic gradient surface is also provided.

### CROSS REFERENCE

This application claims the benefit of Provisional Patent Application No. 60/817,031 filed on Jun. 28, 2006 and is incorporated herein by reference.

### BACKGROUND OF THE INVENTION

1. Technical Field

The present invention generally relates to biocompatible, surface modified materials.

2. Description of Related Art

In the field of biomedical devices such as contact lenses, various factors must be considered in order to yield a material that has appropriate characteristics. For example, various physical and chemical properties such as oxygen permeability, wettability, material strength and stability are but a few of the factors that must be carefully balanced to provide a useable contact lens. Since the cornea receives its oxygen supply exclusively from contact with the atmosphere, good oxygen permeability is a critical characteristic for any contact lens material. Wettability is also important in that, if the lens is not sufficiently wettable, it does not remain lubricated and therefore cannot be worn comfortably in the eye. Accordingly, the optimum contact lens would have at least both excellent oxygen permeability and excellent tear fluid wettability.

For example, contact lenses made from silicone materials have been investigated for a number of years. Such materials can generally be subdivided into two major classes, namely non-hydrogels and hydrogels. Non-hydrogels do not absorb appreciable amounts of water, whereas hydrogels can absorb and retain water in an equilibrium state. Hydrogels generally have a water content greater than about five weight percent and more commonly between about ten to about eighty weight percent. Regardless of their water content, both hydrogel and non-hydrogel silicone contact lenses tend to have relatively hydrophobic, non-wettable surfaces because they are generally cast molded using hydrophobic mold surfaces in the lens casting.

Those skilled in the art have long recognized the need for rendering the surface of contact lenses hydrophilic or more hydrophilic. Increasing the hydrophilicity of the contact-lens surface improves the wettability of the contact lenses with tear fluid in the eye. This in turn improves the wear comfort of the contact lenses. In the case of continuous-wear lenses, the surface is especially important. The surface of a continuous-wear lens must be designed, not only for comfort, but to avoid adverse reactions such as corneal edema, inflammation, or lymphocyte infiltration.

Silicone lenses have been subjected to plasma surface-treatment to improve their surface properties, for example, in order to make the surface more hydrophilic, deposit-resistant, scratch-resistant, and the like. Examples of common plasma surface treatments include subjecting contact lens surfaces to a plasma containing (a) an inert gas or oxygen as, for example, in U.S. Pat. Nos. 4,055,378; 4,122,942; and 4,214,014; (b) various hydrocarbon monomers, for example, those disclosed in U.S. Pat. No. 4,143,949; and (c) combinations of oxidizing agents and hydrocarbons, for example, water and ethanol as, for example, in WO 95/04609 and U.S. Pat. No. 4,632,844. Sequential plasma surface treatments are also known, such as, for example, a first treatment with a plasma of an inert gas or oxygen, followed by a hydrocarbon plasma. For example, U.S. Pat. No. 4,312,575 discloses a process for providing a barrier coating on a silicone or polyurethane lens wherein the lens is subjected to an electrical glow discharge (plasma) involving a hydrocarbon atmosphere followed by oxygen in order to increase the hydrophilicity of the lens surface.

With an oxidizing plasma such as, for example, O₂ (oxygen gas), water, hydrogen peroxide, air, or the like, the plasma tends to etch the surface of the lens, creating radicals and oxidized functional groups. When used as the sole surface treatment, such oxidation renders the surface of a silicone lens more hydrophilic. However, the coverage of such surface treatment may not be complete and the bulk properties of the silicone materials may remain apparent at the surface of the lens, (e.g., silicone molecular chains adjacent the lens surface are capable of rotating thus exposing hydrophobic groups to the outer surface). Such coatings have been found to be thin, whereas thicker coatings tend to crack. Hydrocarbon plasmas, on the other hand, deposit a thin carbon layer (e.g. from a few Angstroms to several thousand Angstroms thick) upon the surface of the lens, thereby creating a barrier between the underlying silicone materials and the outer lens surface. Following deposition of a thin carbon layer on the lens to create a barrier, plasma oxidation can be employed to increase the hydrophilicity of the surface.

Although known surface treatments can be effective in improving the surface properties of non-hydrogel silicone contact lenses, problems are encountered when such treatments are applied to hydrogel lens. Silicone hydrogel lenses are coated in an unhydrated state, but subsequently hydrated during manufacture and prior to use. This hydration causes the lens to dramatically swell, commonly from about 10 to about 20 percent in volume, depending upon the water content of the lens. Such swelling of the lens commonly may cause plasma coatings to crack, delaminate, and/or rub off. Furthermore, plasma coatings can compromise lens hydration by not permitting proper lens expansion and thereby causing lens destruction.

Various patents disclose the attachment of hydrophilic or otherwise biocompatible polymeric chains to the surface of a contact lens in order to render the lens more biocompatible. For example, U.S. Pat. No. 5,652,014 teaches amination of a substrate followed by reaction with other polymers, such as a PEO star molecule or a sulfated polysaccharide. One problem with such an approach is that the polymer chain density is limited due to the difficulty of attaching the polymer to the silicone substrate.

U.S. Pat. No. 5,344,701 discloses the attachment of oxazolinone or azlactone monomers to a substrate by means of plasma. The invention has utility in the field of surface-mediated or catalyzed reactions for synthesis or site-specific separations, including affinity separation of biomolecules, diagnostic supports and enzyme membrane reactors. The oxazolinone group is attached to a porous substrate apparently by reaction of the ethylenic unsaturation in the oxazolinone monomer with radicals formed by plasma on the substrate surface. Alternatively, the substrate can be coated with monomers and reacted with plasma to form a cross-linked coating. The oxazolinone groups that have been attached to the surface can then be used to attach a biologically active material, for example proteins, since the oxazolinone is attacked by amines, thiols, and alcohols. U.S. Pat. Nos. 5,352,714 and 5,364,918 disclose the use of oxazolinone monomers as internal wetting agents for contact lenses, which agents may migrate to the surface of the contact lens.

U.S. Pat. No. 5,618,316 (“the '316 patent”) discloses a soft acrylate lens coated with an aldehyde terminated polyethylene oxide through amine covalent bonding. The '316 patent further discloses that the amine coating is first formed on the lens from plasma deposition of a normal alkyl amine or allyl amine having about 3 to 12 carbon atoms, and the polyethylene oxide coating attaches to the lens surface by reaction of terminal aldehyde groups with the active primary amine groups in the plasma deposited coating. U.S. Pat. No. 6,902,812 discloses the surface treatment of silicone contact lenses and other silicone medical devices by (a) subjecting the surface of a lens substrate to a plasma polymerization deposition with a C₁ to C₁₀ saturated or unsaturated hydrocarbon to form a polymeric carbonaceous layer (or “carbon layer”) on the lens surface; (b) forming reactive functionalities on the surface of the carbon layer; and (c) attaching a preformed hydrophilic polymer to the carbon layer by reacting the reactive functionalities on the carbon layer with complementary isocyanate or ring-opening reactive functionalities along a reactive hydrophilic polymer.

In view of the above, it would be desirable to provide an improved hydrophilic coating for the surface of an ophthalmic lens such as a silicone hydrogel contact lens or other medical device that provides a driving force for forcing water to the surface of the lens (e.g., on a dry lens) or maintaining water on the surface of the lens (e.g., on a semi-hydrated lens) such that the lens is simultaneously tear-wettable and highly permeable to oxygen. Additionally, it would be desirable to form a hydrophilic coating that allows the contact lens or other medical device to be more comfortable and biocompatible for longer periods of time without adverse effects to the cornea.

### SUMMARY OF THE INVENTION

In accordance with one embodiment of the present invention, a biomedical device having a hydrophilic gradient surface is provided, wherein the hydrophilic gradient surface comprises (a) a first layer having a first contact angle; (b) a second layer having a second contact angle, the second contact angle being less than the first contact angle of the first layer; and (c) a third layer having a third contact angle, the third contact angle being less than the first and second contact angles of the first and second layers.

In accordance with a second embodiment of the present invention, a method for increasing hydrophilicity or wettability of a biomedical device having a hydrophilic gradient surface is provided, the method comprising applying to the surface of the biomedical device a hydrophilic gradient coating comprising (a) a first layer having a first contact angle; (b) a second layer having a second contact angle, the second contact angle being less than the first contact angle of the first layer; and (c) a third layer having a third contact angle, the third contact angle being less than the first and second contact angles of the first and second layers.

### DETAILED DESCRIPTION OF THE PREFERRED EMBODIMENTS

The present invention is directed toward surface treatment of biomedical devices intended for direct contact with body tissue or body fluid including ophthalmic lens applications, where the lens is intended for direct placement in or on the eye such as, for example, intraocular lenses, contact lenses, vascular lenses and the like, to improve their biocompatibility. As used herein, a “biomedical device” is any article that is designed to be used while either in or on mammalian tissues or fluid and preferably in or on human tissues or fluid. Examples of such devices include, but are not limited to, catheters, implants, stents, and ophthalmic devices such as intraocular lenses and contact lenses. The preferred biomedical devices are ophthalmic devices, more preferably contact lenses, and most preferably contact lenses made from silicone hydrogels.

As used herein, the terms “lens” and “opthalmic device” refer to devices that reside in or on the eye. These devices can provide optical correction, wound care, drug delivery, diagnostic functionality or cosmetic enhancement or effect or a combination of these properties. Representative examples of such devices include, but are not limited to, soft contact lenses, e.g., soft, hydrogel lens, soft, non-hydrogel lens and the like, hard contact lenses, e.g., hard, gas permeable lens materials and the like, intraocular lenses, overlay lenses, ocular inserts, optical inserts and the like. As is understood by one skilled in the art, a lens is considered to be “soft” if it can be folded back upon itself without breaking. Any material known to produce a biomedical device including an ophthalmic device can be used herein.

For example, in one embodiment, the present invention is directed toward surface treatment of biomedical devices, e.g., contact lenses, intraocular lenses and vascular implants. In one embodiment, the biomedical devices are hydrophobic substrates. In another embodiment, the biomedical devices are silicone biomedical devices. The term “silicone” as used herein shall be understood to mean that the material being treated is an organic polymer comprising at least about 5 percent by weight silicone (—OSi— linkages), preferably about 10 to about 100 percent by weight silicone, and more preferably about 30 to about 90 percent by weight silicone. The present invention has been found very advantageous for application to contact lenses, either silicone hydrogels or silicone rigid-gas-permeable materials. The invention is especially advantageous for silicone hydrogel continuous-wear lenses. Hydrogels are a well-known class of materials, which comprise hydrated, cross-linked polymeric systems containing water in an equilibrium state. Silicone hydrogels generally have a water content greater than about 5 weight percent, commonly between about 10 to about 80 weight percent and more commonly between about 20 to about 55 weight percent. Such materials are usually prepared by polymerizing a mixture containing at least one silicone-containing monomer and at least one hydrophilic monomer. Either the silicone-containing monomer or the hydrophilic monomer may function as a cross-linking agent (a cross-linker being defined as a monomer having multiple polymerizable functionalities) or a separate cross-linker may be employed. Applicable silicone-containing monomeric units for use in the formation of silicone hydrogels are well known in the art and numerous examples are provided in, for example, U.S. Pat. Nos. 4,136,250; 4,153,641; 4,740,533; 5,034,461; 5,070,215; 5,260,000; 5,310,779; and 5,358,995.

Representative examples of applicable silicon-containing monomeric units include bulky polysiloxanylalkyl(meth)acrylic monomers. An example of a bulky polysiloxanylalkyl(meth)acrylic monomer is represented by the structure of Formula I:

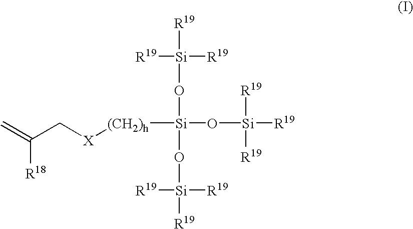

wherein X denotes —O— or —NR—; each R¹⁸ independently denotes hydrogen or methyl; each R¹⁹ independently denotes a lower alkyl radical, phenyl radical or a group represented by

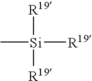

wherein each R¹⁹′ independently denotes a lower alkyl or phenyl radical; and h is 1 to 10.

Examples of bulky monomers are methacryloxypropyl tris(trimethylsiloxy)silane or tris(trimethylsiloxy)silylpropyl methacrylate, sometimes referred to as TRIS and tris(trimethylsiloxy)silylpropyl vinyl carbamate, sometimes referred to as TRIS-VC and the like.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis[4-vinyloxycarbonyloxy)but-1-yl]tetramethyl-disiloxane; 3-(trimethylsilyl)propylvinylcarbonate; 3-(vinyloxycarbonylthio)propyl-[tris(trimethylsiloxy)silane]; 3-[tris(trimethylsiloxy)silyl]propylvinylcarbamate; 3-[tris(trimethylsiloxy)silyl]propylallylcarbamate; 3-[tris(trimethylsiloxy)silyl]propylvinylcarbonate; carbonate; t-butyldimethylsiloxyethylvinylcarbonate; trimethylsilylethylvinylcarbonate; trimethylsilylmethylvinylcarbonate and the like.

Another class of silicon-containing monomers includes polyurethanepolysiloxane macromonomers (also sometimes referred to as prepolymers), which may have hard-soft-hard blocks like traditional urethane elastomers. Examples of silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 also discloses examples of such monomers, the contents of which are hereby incorporated by reference in its entirety. Further examples of silicone urethane monomers are represented by Formulae II and III:

E(*D*A*D*G)ₐ*D*A*D*E′; or (II)

E(*D*G*D*A)ₐ*D*A*D*E′; or (III)

wherein:

D denotes an alkyl diradical, an alkyl cycloalkyl diradical, a cycloalkyl diradical, an aryl diradical or an alkylaryl diradical having 6 to about 30 carbon atoms;

G denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;

* denotes a urethane or ureido linkage;

a is at least 1;

A denotes a divalent polymeric radical of Formula IV:

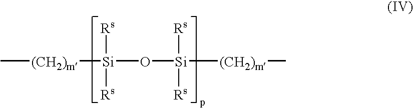

wherein each R⁵ independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

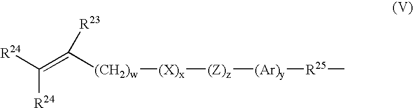

wherein: R²³ is hydrogen or methyl;
R²⁴ is hydrogen, an alkyl radical having 1 to 6 carbon atoms, or a —CO—Y—R²⁶ radical wherein Y is —O—, —S— or —NH—;
R²⁵ is a divalent alkylene radical having 1 to about 10 carbon atoms;
R²⁶ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

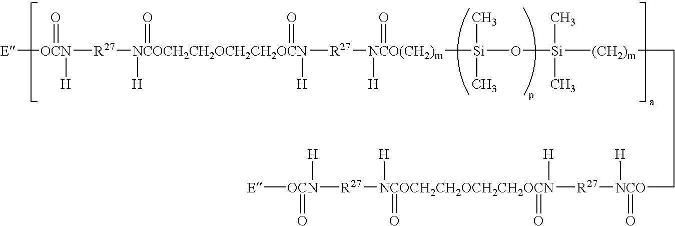

wherein m is at least 1 and is preferably 3 or 4, a is at least 1 and preferably is 1, p is a number which provides a moiety weight of about 400 to about 10,000 and is preferably at least about 30, R²⁷ is a diradical of a diisocyanate after removal of the isocyanate group, such as the diradical of isophorone diisocyanate, and each E″ is a group represented by:

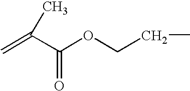

Another class of representative silicone-containing monomers includes fluorinated monomers. Such monomers have been used in the formation of fluorosilicone hydrogels to reduce the accumulation of deposits on contact lenses made therefrom, as described in, for example, U.S. Pat. Nos. 4,954,587; 5,010,141 and 5,079,319. The use of silicone-containing monomers having certain fluorinated side groups, i.e., —(CF₂)—H, have been found to improve compatibility between the hydrophilic and silicone-containing monomeric units, see, e.g., U.S. Pat. Nos. 5,321,108 and 5,387,662.

In another embodiment of the invention, a silicone hydrogel material comprises (in bulk, that is, in the monomer mixture that is copolymerized) about 5 to about 50 percent, and preferably about 10 to about 25, by weight of one or more silicone macromonomers, about 5 to about 75 percent, and preferably about 30 to about 60 percent, by weight of one or more polysiloxanylalkyl (meth)acrylic monomers, and about 10 to about 50 percent, and preferably about 20 to about 40 percent, by weight of a hydrophilic monomer. Examples of hydrophilic monomers include, but are not limited to, ethylenically unsaturated lactam-containing monomers such as N-vinyl pyrrolidinone, methacrylic and acrylic acids; acrylic substituted alcohols, such as 2-hydroxyethylmethacrylate and 2-hydroxyethylacrylate and acrylamides, such as methacrylamide and N,N-dimethylacrylamide, vinyl carbonate or vinyl carbamate monomers such as those disclosed in U.S. Pat. No. 5,070,215, and oxazolinone monomers such as those disclosed in U.S. Pat. No. 4,910,277. Other hydrophilic monomers will be apparent to one skilled in the art.

The above silicone materials are merely exemplary, and other materials for use as substrates that can benefit by being coated with the hydrophilic gradient coating according to the present invention and have been disclosed in various publications and are being continuously developed for use in contact lenses and other medical devices can also be used.

The biomedical devices of the present invention, e.g., contact lenses or intraocular lenses, can be manufactured by conventional manufacturing processes. For example, contact lenses can be manufactured employing various conventional techniques, to yield a shaped article having the desired posterior and anterior lens surfaces. For example, spincasting methods are disclosed in U.S. Pat. Nos. 3,408,429 and 3,660,545; preferred static casting methods are disclosed in U.S. Pat. Nos. 4,113,224 and 4,197,266. Curing of the monomeric mixture is often followed by a machining operation in order to provide a contact lens having a desired final configuration. As an example, U.S. Pat. No. 4,555,732 discloses a process in which an excess of a monomeric mixture is cured by spincasting in a mold to form a shaped article having an anterior lens surface and a relatively large thickness. The posterior surface of the cured spincast article is subsequently lathe cut to provide a contact lens having the desired thickness and posterior lens surface. Further machining operations may follow the lathe cutting of the lens surface, for example, edge-finishing operations.

After producing a lens having the desired final shape, it may be desirable to remove residual solvent from the lens before edge-finishing operations. This is because, typically, an organic diluent is included in the initial monomeric mixture in order to minimize phase separation of polymerized products produced by polymerization of the monomeric mixture and to lower the glass transition temperature of the reacting polymeric mixture, which allows for a more efficient curing process and ultimately results in a more uniformly polymerized product. Sufficient uniformity of the initial monomeric mixture and the polymerized product are of particular concern for silicone hydrogels, primarily due to the inclusion of silicone-containing monomers which may tend to separate from the hydrophilic comonomer. Suitable organic diluents include, but are not limited to, monohydric alcohols such as C₆-C₁₀ straight-chained aliphatic monohydric alcohols, e.g., n-hexanol, n-nonanol and the like; diols such as ethylene glycol and the like; polyols such as glycerin and the like; ethers such as diethylene glycol monoethyl ether and the like; ketones such as methyl ethyl ketone and the like; esters such as methyl enanthate and the like; and hydrocarbons such as toluene and the like. Preferably, the organic diluent is sufficiently volatile to facilitate its removal from a cured article by evaporation at or near ambient pressure. Generally, the diluent is included at about five to about sixty percent by weight of the monomeric mixture, with about ten to about fifty percent by weight being especially preferred.

The cured lens is then subjected to solvent removal, which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. According to a preferred embodiment, the temperature employed in the removal step is preferably at least about 50° C., for example, about 60° C. to about 80° C. A series of heating cycles in a linear oven under inert gas or vacuum may be used to optimize the efficiency of the solvent removal. The cured article after the diluent removal step should contain no more than about twenty percent by weight of diluent, preferably no more than about five percent by weight or less.

Following removal of the organic diluent, the lens is next subjected to mold release and optional machining operations, e.g., buffing or polishing a lens edge and/or surface. Generally, such machining processes may be performed before or after the article is released from a mold part. Preferably, the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

Next, the surface of the biomedical device thus obtained will be subjected to surface treatments to provide a biomedical device having a hydrophilic gradient surface of the present invention. By forming the hydrophilic gradient herein on the surface of a biomedical device, the device, e.g., a lens, will advantageously possess an increased hydrophilicity from the bottom layer of the gradient, i.e., the layer closest to the surface of the lens, to the top layer of the gradient, i.e., the gradient will be less hydrophilic at the surface of the lens and will be more hydrophilic at the top of the gradient. Generally, the hydrophilic gradient coating on the surface of the biomedical devices of the present invention will include at least (a) a first layer having a first contact angle; (b) a second layer having a second contact angle less than the first contact angle of the first layer; and (c) a third layer having a third contact angle less than the first and second contact angles of the first and second layers. Generally, when using a probe liquid such as distilled water for a desalinated and dried silicone hydrogel contact lens material, the first layer can have a first contact angle of greater than or equal to about 100 degrees, preferably from about 100 to about 120 and most preferably from about 100 to about 110 degrees; the second layer having a second contact angle less than the first contact angle of the first layer can have a contact angle of greater than about 70 degrees, preferably from about 70 to about 99 degrees and most preferably from about 70 to about 80 degrees; and the third layer having a third contact angle less than the first and second contact angles of the first and second layers can have a contact angle of no greater than about 69 degrees, preferably from about 40 to about 69 degrees and most preferably from about 40 to about 55 degrees. The contact angles of each respective layer can be determined according to the Sessile Drop Method as expanded upon by Zisman et al., J. Colloid Sci., Vol. 1, p. 513 (1946). In the method, the biomedical device is placed on a flat plate in a goniometer such as a Rane-Hart. Next, a drop of liquid of interest (e.g., distilled water, buffered saline or any other probe liquid of interest) is applied to the device through a metered syringe. The angle can be read from the viewer, after adjusting the baseline.

As one skilled in the art would readily appreciate, other methods for determining contact angles known in the art can also be employed. Representative examples of such methods for determining a contact angle include an expanded sessile drop technique using multiple liquids of homologous series to generate Zisman plots to obtain the critical surface tension, or theta condition that is determined from a Baier plot of bioadhesion; dynamic contact angles based on the Wilhelmy plate technique; and the captive bubble technique in which the contact angle is of an air bubble at the interface between the solid test surface and a chosen liquid medium. Generally, the contact angle at an interface is dependent on the solid-liquid-gas interface, and is dependent on the properties of all three. Hence, a contact angle for a solid test material can greatly change by a change in the choice of the liquid, such as a change from distilled water to borate buffered saline. For the sake of the example herein disclosed, the liquid medium is fixed and the solid test surface has a change in the surface from one layer to the next. Such a measure of hydrophilicity is indicated when using a liquid for the contact angle analysis that is hydrophilic, so that a reduced contact angle on the surface is indicative of a decreased hydrophobicity and thus an increased hydrophilicity. If a liquid, or series of liquids, are used such that they have a hydrophobic character, then an increasing contact angle from layer to layer would be indicative of increasing hydrophilicity. Additionally, various analytical techniques such as angle dependent X-ray photoelectron spectroscopy (AD-XPS), or XPS with the use of various ion guns of varying ion mass can be used to confirm that each of the individual layers are present on the surface of the biomedical device.

By controlling the surface characteristics of a biomedical device such as an ophthalmic lens, it is believed to be possible to provide a biomedical device which can exhibit superior water wettability of the lens surface for a long wearing period, high oxygen permeability, reduced protein and lipid depositions, stable lens movement, and little adhesion to a cornea. Preferably, a soft contact lens enabling continuous wearing for at least about 30 days can be realized by keeping the contact angle of each layer of the hydrophilic gradient on the lens's surface in the aforementioned ranges.

Prior to forming the hydrophilic gradient surface on the biomedical device, it may be advantageous to preliminary treat the surface of the device to more effectively bond the hydrophilic gradient coating to the surface of the device. For example, the surface of the biomedical device can initially be subjected to a plasma-oxidation reaction Generally, the surface of the biomedical device can be subjected to the plasma-oxidation reaction so as to more effectively bond the polymerized hydrocarbon coating to the lens in order to resist delamination and/or cracking of the surface coating from the lens upon lens hydration. Pretreatment is especially preferred in the case of a silicone hydrogel substrate. It has been found that by subjecting a silicone hydrogel lens material to plasma oxidation, the surface of the lens is prepared to better bind the hydrophilic gradient that is subsequently deposited on the lens. Thus, for example, if the lens is ultimately made from a hydrogel material that is hydrated (wherein the lens typically expands by about ten to about twenty percent), the coating remains intact and bound to the lens, providing a more durable coating which is resistant to delamination or cracking, or excessive amounts thereof.

As mentioned above, it is preferred to initially oxidize the surface of the device, e.g., a silicone hydrogel continuous-wear lens, by the use of an oxidation plasma to render the subsequent deposition of the hydrophilic gradient more adherent to the lens. The plasma oxidation and deposition processes used herein are standard plasma oxidation and deposition processes (also referred to as “electrical glow discharge processes”) to provide a thin, durable surface upon the biomedical device prior to attachment of the hydrophilic gradient coating. Representative examples of such plasma processes are provided in U.S. Pat. Nos. 4,143,949; 4,312,575; and 5,464,667.

Generally, plasma treatment involves passing an electrical discharge through a gas at low pressure, preferably at radio frequency (typically, 13.56 MHz). As mentioned above, this electrical discharge is absorbed by atoms and molecules in their gas state, thus forming a plasma that interacts with the surface of the contact lens.

The deposition of a coating from a plasma onto the surface of a material has been shown to be possible from high-energy plasmas without the assistance of sputtering (sputter-assisted deposition). Monomers can be deposited from the gas phase and polymerized in a low pressure atmosphere (about 0.005 to about 5 torr, and preferably about 0.001 to about 1 torr) onto a substrate utilizing continuous or pulsed plasmas, suitably as high as about 1000 watts. A modulated plasma, for example, may be applied about 100 milliseconds on then off. In addition, liquid nitrogen cooling has been utilized to condense vapors out of the gas phase onto a substrate and subsequently use the plasma to chemically react these materials with the substrate. However, plasmas do not require the use of external cooling or heating to cause the deposition. Low or high wattage (e.g., about 5 to about 1000, and preferably about 20 to about 500 watts) plasmas can coat even the most chemical-resistant substrates, including silicones.

After initiation by a low energy discharge, collisions between energetic free electrons present in the plasma cause the formation of ions, excited molecules, and free-radicals. Such species, once formed, can react with themselves in the gas phase as well as with further ground-state molecules. The plasma treatment may be understood as an energy dependent process involving energetic gas molecules. For chemical reactions to take place at the surface of the lens, one needs the required species (element or molecule) in terms of charge state and particle energy. Radio frequency plasmas generally produce a distribution of energetic species. Typically, the “particle energy” refers to the average of the so-called Boltzman-style distribution of energy for the energetic species. In a low-density plasma, the electron energy distribution can be related by the ratio of the electric field strength sustaining the plasma to the discharge pressure (E/p). The plasma power density P is a function of the wattage, pressure, flow rates of gases, etc., as will be appreciated by the skilled artisan. Background information on plasma technology, hereby incorporated by reference, includes the following: A. T. Bell, Proc. Intl. Conf. Phenom. Ioniz. Gases, “Chemical Reaction in Nonequilibrium Plasmas”, 19-33 (1977); J. M. Tibbitt, R. Jensen, A. T. Bell, M. Shen, Macromolecules, “A Model for the Kinetics of Plasma Polymerization”, 3, 648-653 (1977); J. M. Tibbitt, M. Shen, A. T. Bell, J. Macromol. Sci.-Chem., “Structural Characterization of Plasma-Polymerized Hydrocarbons”, A10, 1623-1648 (1976); C. P. Ho, H. Yasuda, J. Biomed, Mater. Res., “Ultrathin coating of plasma polymer of methane applied on the surface of silicone contact lenses”, 22, 919-937 (1988); H. Kobayashi, A. T. Bell, M. Shen, Macromolecules, “Plasma Polymerization of Saturated and Unsaturated Hydrocarbons”, 3, 277-283 (1974); R. Y. Chen, U.S. Pat. No., 4,143,949, Mar. 13, 1979, “Process for Putting a Hydrophilic Coating on a Hydrophobic Contact lens”; and H. Yasuda, H. C. Marsh, M. O. Bumgarner, N. Morosoff, J. of Appl. Poly. Sci., “Polymerization of Organic Compounds in an Electroless Glow Discharge. VI. Acetylene with Unusual Co-monomers”, 19, 2845-2858 (1975).

Based on this previous work in the field of plasma technology, the effects of changing pressure and discharge power on the rate of plasma modification can be understood. The rate generally decreases as the pressure is increased. Thus, as pressure increases the value of E/p, the ratio of the electric field strength sustaining the plasma to the gas pressure decreases and causes a decrease in the average electron energy. The decrease in electron energy in turn causes a reduction in the rate coefficient of all electron-molecule collision processes. A further consequence of an increase in pressure is a decrease in electron density. Providing that the pressure is held constant, there should be a linear relationship between electron density and power.

In practice, contact lenses are surface-treated by placing them, in their unhydrated state, within an electric glow discharge reaction vessel (e.g., a vacuum chamber). Such reaction vessels are commercially available. The lenses may be supported within the vessel on an aluminum tray (which acts as an electrode) or with other support devices designed to adjust the position of the lenses. The use of a specialized support devices which permit the surface treatment of both sides of a lens are known in the art and may be used herein.

Oxidation of the lens may be accomplished in an atmosphere composed of at least an oxidizing media such as an oxygen or nitrogen containing compound, e.g., ammonia, an aminoalkane, air, water, peroxide, O₂ (oxygen gas), methanol, acetone, alkylamines, and the like and combinations thereof, and at an electric discharge frequency of about 13.56 Mhz, and preferably between about 20 to about 500 watts at a pressure of about 0.1 to about 1.0 torr, preferably for about 10 seconds to about 10 minutes or more, and more preferably about I to 10 minutes. Preferably, the oxidizing media is a nitrogen-containing compound and more preferably ammonia. It is preferred that a relatively “strong” oxidizing plasma is utilized in this initial oxidation, for example, ambient air drawn through an about 5% hydrogen peroxide solution. As one skilled in the art will readily appreciate, other methods of improving or promoting adhesion for bonding of the subsequent carbon layer can be used. For example, plasma with an inert gas or deposition of a silicon-containing monomer to promote adhesion will also improve bonding.

After the optional oxidative surface treatment, the hydrophilic gradient can then be applied the lens surface. Generally, each layer of the hydrophilic gradient surface can include any material so as the material provides a layer having a contact angle as discussed hereinabove. For example, in one embodiment, the first layer can be a hydrocarbon polymeric layer formed by subjecting the surface to a plasma polymerization reaction in a hydrocarbon atmosphere to form a polymeric surface on the lens. Any hydrocarbon capable of polymerizing in a plasma environment may be utilized; however, it is usually necessary that the hydrocarbon be in a gaseous state during polymerization and have a boiling point below about 200° C. at about one atmosphere. Suitable hydrocarbons include, but are not limited to, linear or branched, saturated and unsaturated, C₁ to about C₁₅ aliphatic compounds, C₁ to about C₈ aromatic compounds and the like and mixtures thereof. Examples of such aliphatic hydrocarbons include, but are not limited to, C₁ to about C₁₅, and preferably C₁ to about C₁₀ alkanes, alkenes, or alkynes and the like. Specific examples of suitable aliphatic hydrocarbons include methane, ethane, propane, butane, pentane, hexane, ethylene, propylene, butylene, cyclohexane, pentene, acetylene and the like. Specific examples of suitable aromatic hydrocarbons include benzene, styrene, methylstyrene, and the like. As is known in the art, such hydrocarbon groups may be unsubstituted or substituted so long as they are capable of forming a plasma. In one embodiment, the hydrocarbon is a diolefin such as, for example, 1,3-butadiene or isoprene, resulting in coatings that are more flexible and expandable in water. More flexible coatings are especially preferred for “high-water” lenses that expand considerably upon hydration.

The hydrocarbon coating can be deposited from plasma, for example, in a low-pressure atmosphere (about 0.001 to about 5 torr) at a radio frequency of about 13.56 Mhz, at about 10 to about 1000 watts, and preferably about 20 to about 400 watts in about 30 seconds to about 10 minutes or more, and more preferably about 30 seconds to about 3 minutes. Other plasma conditions may be suitable as will be understood by the skilled artisan, for example, using pulsed plasma.

If the hydrocarbon coating provided is too thick, it can cause a haziness, resulting in a cloudy lens. Furthermore, excessively thick coatings can interfere with lens hydration due to differences in expansion between the lens and the coating, causing the lens to rip apart. Therefore, the thickness of the hydrocarbon layer should ordinarily be less than about 500 Angstroms, preferably from about 25 to about 500 Angstroms, and more preferably from about 50 to about 200 Angstroms, as determined by XPS analysis.

If desired, the hydrocarbon layer may then be subjected to addition surface treatment, including plasma oxidation or other means to provide surface reactive functional groups that can react with the second layer of the hydrophilic gradient coating. For example, a nitrogen-containing gas can be used to form amine groups on the carbon layer. However, oxygen or sulfur containing gases may alternatively be used to form oxygen or sulfur containing groups, for example, hydroxy or sulfide groups or radicals, on the carbon layer. The carbon layer can therefore be rendered reactive (functionalized) to promote the covalent attachment of the second layer to the surface.

To create a reactive functional group on the hydrocarbon layer, such an oxidation preferably utilizes a gas composition containing an oxidizing media such as, for example, ammonia, ethylene diamine, C₁ to about C₈ alkyl amine, hydrazine, or other oxidizing compounds. Preferably, the oxidation of the hydrocarbon layer is performed for a period of about 10 seconds to about 10 minutes or more, and more preferably about 1 to about 10 minutes, a discharge frequency of about 13.56 Mhz at about 10 to about 1000 watts, and preferably about 20 to about 500 watts and about 0.1 to about 1 torr. The lens substrate may be treated on both sides at once or each side sequentially.

Other material useful in forming the layers of the hydrophilic gradient coating can be hydrophilic polymers obtained from the polymerization of a monomeric mixture containing at least one or more hydrophilic monomers. Suitable hydrophilic monomers include, but are not limited to, conventional vinyl monomers such as

A. Acrylate and/or Methacrylate-Containing Monomers Represented by General Formula VII:

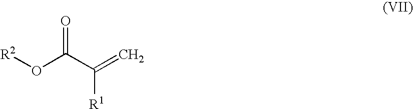

wherein R¹ is H or CH₃ and R² is an aliphatic hydrocarbon group of up to about 10 carbon atoms; C₃-C₁₈ cycloalkyl, C₃-C₁₈ cycloalkylalkyl, C₃-C₁₈ cycloalkenyl, C₅-C₃₀ aryl, C₅-C₃₀ arylalkyl, ether or polyether containing groups, linear or branched, unsubstituted or substituted by one or more water solubilizing groups such as carboxy, hydroxy, amino, lower alkylamino, lower dialkyamino, a polyethylene oxide group having from 2 to about 100 repeating units, or substituted by one or more sulfate, phosphate sulfonate, phosphonate, carboxamido, sulfonamido or phosphonamido groups, or mixtures thereof.

For example, R² can be an oligomer or polymer such as polyethylene glycol, polypropylene glycol, poly(ethylene-propylene) glycol, poly(hydroxyethyl methacrylate), poly(dimethyl acrylamide), poly(acrylic acid), poly(methacrylic acid), polysulfone, poly(vinyl alcohol), polyacrylamide, poly(acrylamide-acrylic acid) poly(styrene sulfonate) sodium salt, poly(ethylene oxide), poly(ethylene oxide-propylene oxide), poly(glycolic acid), poly(lactic acid), poly(vinylpyrrolidone), cellulosics, polysaccharides, mixtures thereof, and copolymers thereof.

Representative examples of alkyl groups for use herein include, by way of example, a straight or branched hydrocarbon chain radical containing carbon and hydrogen atoms of from 1 to about 18 carbon atoms with or without unsaturation, to the rest of the molecule, e.g., methyl, ethyl, n-propyl, 1-methylethyl (isopropyl), n-butyl, n-pentyl, etc., and the like.

Representative examples of cycloalkyl groups for use herein include, by way of example, a substituted or unsubstituted non-aromatic mono or multicyclic ring system of about 3 to about 18 carbon atoms such as, for example, cyclopropyl, cyclobutyl, cyclopentyl, cyclohexyl, perhydronapththyl, adamantyl and norbornyl groups bridged cyclic group or sprirobicyclic groups, e.g., sprio-(4,4)-non-2-yl and the like, optionally containing one or more heteroatoms, e.g., O and N, and the like.

Representative examples of cycloalkylalkyl groups for use herein include, by way of example, a substituted or unsubstituted cyclic ring-containing radical containing from about 3 to about 18 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like.

Representative examples of cycloalkenyl groups for use herein include, by way of example, a substituted or unsubstituted cyclic ring-containing radical containing from about 3 to about 18 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like.

Representative examples of aryl groups for use herein include, by way of example, a substituted or unsubstituted monoaromatic or polyaromatic radical containing from about 5 to about 25 carbon atoms such as, for example, phenyl, naphthyl, tetrahydronapthyl, indenyl, biphenyl and the like, optionally containing one or more heteroatoms, e.g., O and N, and the like.

Representative examples of arylalkyl groups for use herein include, by way of example, a substituted or unsubstituted aryl group as defined above directly bonded to an alkyl group as defined above, e.g., —CH₂C₆H₅, —C₂H₅C₆H₅ and the like, wherein the aryl group can optionally contain one or more heteroatoms, e.g., O and N, and the like.

Representative examples of ether or polyether containing groups for use herein include, by way of example, an alkyl ether, cycloalkyl ether, cycloalkylalkyl ether, cycloalkenyl ether, aryl ether, arylalkyl ether wherein the alkyl, cycloalkyl, cycloalkylalkyl, cycloalkenyl, aryl, and arylalkyl groups are defined above, e.g., alkylene oxides, poly(alkylene oxide)s such as ethylene oxide, propylene oxide, butylene oxide, poly(ethylene oxide)s, poly(ethylene glycol)s, poly(propylene oxide)s, poly(butylene oxide)s and mixtures or copolymers thereof, an ether or polyether group of the general formula —R³OR⁴, wherein R³ is a bond, an alkyl, cycloalkyl or aryl group as defined above and R⁴ is an alkyl, cycloalkyl or aryl group as defined above, e.g., —CH₂CH₂OC₆H₅ and —CH₂CH₂OC₂H₅, and the like.

The substituents in the ‘substituted alkyl’, ‘substituted cycloalkyl’, ‘substituted cycloalkylalkyl’, ‘substituted cycloalkenyl’, ‘substituted arylalkyl’ and ‘substituted aryl’ may be the same or different with one or more selected from the group such as hydrogen, halogen (e.g., fluorine), substituted or unsubstituted alkyl, substituted or unsubstituted alkoxy, substituted or unsubstituted alkenyl, substituted or unsubstituted alkynyl, substituted or unsubstituted aryl, substituted or unsubstituted arylalkyl, substituted or unsubstituted cycloalkyl, substituted or unsubstituted cycloalkenyl, substituted or unsubstituted aryl, substituted or unsubstituted heteroaryl, substituted heterocyclylalkyl ring, substituted or unsubstituted heteroarylalkyl, substituted or unsubstituted heterocyclic ring.

In one embodiment, useful acrylate or methacrylate-containing monomers include, but are not limited to, a linear or branched, substituted or unsubstituted, C₁ to C₁₈ alkyl acrylate, a linear or branched, substituted or unsubstituted, C₁ to C₁₈ alkyl methacrylate, a substituted or unsubstituted C₃ to C₁₈ cycloalkyl acrylate, a substituted or unsubstituted C₃ to C₁₈ cycloalkyl methacrylate, a substituted or unsubstituted C₆ to C₂₅ aryl or alkaryl acrylate, a substituted or unsubstituted C₆ to C₂₅ aryl or alkaryl methacrylate, an ethoxylated acrylate, an ethoxylated methacrylate, partially fluorinated acrylates, partially fluorinated methacrylates and the like and mixtures thereof.

Representative examples of acrylate-containing monomers for use herein include, but are not limited to, methyl acrylate, ethyl acrylate, propyl acrylate, isopropyl acrylate, n-butyl acrylate, iso-butyl acrylate, t-butyl acrylate, n-hexyl acrylate, 2-ethylbutyl acrylate, 2-ethylhexyl acrylate, cyclopropyl acrylate, cyclobutyl acrylate, cyclohexyl acrylate, benzyl acrylate, 2-phenoxyethyl acrylate, phenyl acrylate, 2-phenylethyl acrylate, 3-phenylpropyl acrylate, 3-phenoxypropyl acrylate, 4-phenylbutyl acrylate, 4-phenoxybutyl acrylate, 4-methylphenyl acrylate, 4-methylbenzyl acrylate, 2-2-methylphenylethyl acrylate, 2-3-methylphenylethyl acrylate, 2-methylphenylethyl acrylate and the like and mixtures thereof.

Representative examples of methacrylate-containing monomers for use herein include, but are not limited to, methyl methacrylate, ethyl methaerylate, propyl methacrylate, isopropyl methacrylate, n-butyl methacrylate, iso-butyl methacrylate, t-butyl methacrylate, n-hexyl methacrylate, 2-ethylbutyl methacrylate, 2-ethylhexyl methacrylate, cyclopropyl methacrylate, cyclobutyl methacrylate, cyclohexyl methacrylate, benzyl methacrylate, 2-phenoxyethyl methacrylate, phenyl methacrylate, 2-phenylethyl methacrylate, 3-phenylpropyl methacrylate, 3-phenoxypropyl methacrylate, 4-phenylbutyl methacrylate, 4-phenoxybutyl methacrylate, 4-methylphenyl methacrylate, 4-methylbenzyl methacrylate, 2-2-methylphenylethyl methacrylate, 2-3-methylphenylethyl methacrylate, 2-4-methylphenylethyl methacrylate and the like and mixtures thereof.

B. Acrylamido or Methacrylamido-Containing Monomers Represented by General Formulae VIII and IX

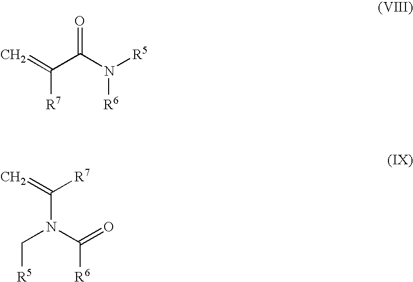

wherein R⁵ and R⁶ are independently hydrogen, a C₁-C₁₈ alkyl, C₃-C₁₈ cycloalkyl, C₃-C₁₈ cycloalkylalkyl, C₃-C₁₈ cycloalkenyl, C₅-C₃₀ aryl, or C₅-C₃₀ arylalkyl, substituted or unsubstituted, linear or branched, as defined above or R⁵ and R⁶ together with the nitrogen atom to which they are bonded are joined together to form a heterocyclic group and R⁷ is H or CH₃. In one embodiment, R⁵ is hydrogen and R⁶ is R² as defined above.

Representative examples of acrylamido-containing monomers include, but are not limited to, acrylamide, N-methylacrylamide, N-ethylacrylamide, N-propylacrylamide, N-isopropylacrylamide, N-butylacrylamide, N,N-dimethylacrylamide, N,N-diethylacrylamide, N,N-dipropylacrylamide, N,N-dibutylacrylamide, N,N-methylethylacrylamide, N,N-methylpropylacrylamide, N,N-ethylpropylacrylamide, N,N-ethylbutylacrylamide, N,N-propylbutylacrylamide, N-cyclopropylacrylamide, N-cyclobutylacrylamide, N-vinylpyrrolidone and the like and mixtures thereof.

C. Maleate and Fumarate-Containing Monomers Represented by General Formula X:

R²OOCH═CHCOOR² (X)

wherein R² is as defined above. Representative examples include itaconic, crotonic, fumaric and maleic acids and the lower hydroxyalkyl mono and diesters thereof such as the 2-hydroxethyl fumarate and maleate.

D. Vinyl Ether-Containing Monomers Represented by General Formula XI:

H₂C═CH—O—R² (XI)

wherein R² is as defined above.

E. Aliphatic Vinyl-Containing Monomers Represented by General Formula XII:

R¹CH═CHR² (XII)

wherein R¹ is as defined above and R² is as defined above with the proviso that R² is other than hydrogen.

F. Vinyl Substituted Heterocycles, such as Vinyl Pyridines, Piperidines and Imidazoles.

Additional hydrophilic reactive monomers are ether-containing monomers including, by way of example, an alkyl ether, cycloalkyl ether, cycloalkylalkyl ether, cycloalkenyl ether, aryl ether, arylalkyl ether wherein the alkyl, cycloalkyl, cycloalkylalkyl, cycloalkenyl, aryl, and arylalkyl groups are defined above. Representative examples of ether-containing monomers include alkylene oxides such as ethylene oxide, propylene oxide, butylene oxide, and the like, an ether group of the general formula —R⁸OR⁹, wherein R⁸ is a bond, an alkyl, cycloalkyl or aryl group as defined above and R⁹ is an alkyl, cycloalkyl or aryl group as defined above, e.g., —CH₂CH₂OC₆H₅ and —CH₂CH₂OC₂H₅, and the like. It is advantageous to employ one or more layers of the hydrophilic gradient based on a hydrophilic polyalkylether polymer as they are known for their lubricious nature, and low coefficient of friction, because of the hydrogen bound water that is retained even when a high polymer is formed, and are considered to be very biocompatible. In one embodiment, each layer of the hydrophilic gradient is formed from a polymerization product of a monomeric mixture containing at least one or more alkylene oxides. In another embodiment, the first layer of the hydrophilic gradient is a polymer, copolymer or terpolymer containing at least one or more butylene oxide units, the second layer is a polymer, copolymer or terpolymer containing at least one or more propylene oxide units and the third layer is a polymer, copolymer or terpolymer containing at least one or more ethylene oxide units wherein the surface of the substrate is optionally subjected to an oxidative surface treatment, and optionally followed by the addition of a hydrocarbon layer optionally containing reactive functionalities as discussed hereinabove.

Yet other hydrophilic reactive monomers include zwitterions such as N,N-dimethyl-N-methacryloxyethyl-N-(3-sulfopropyl)-ammonium betain (SPE) and N,N-dimethyl-N-methacrylamidopropyl-N-(3-sulfopropyl)-ammonium betain (SPP). Other hydrophilic reactive monomers include titanium-containing hydrophilic reactive monomers.

The hydrophilic polymer may be the reaction product of a monomeric mixture containing at least one or more reactive functional monomers and, optionally, one or more non-reactive hydrophilic monomers and/or one or more hydrophobic monomers. In this case, the reactive functional monomeric unit will complementarily react with a surface having reactive functionalities, for example, as provided by plasma oxidation. Such reactive functional monomers may include any of the monomers discussed hereinabove or one or more monomers containing one or more of the following groups: cyanate (—CNO), or various ring-opening reactive groups, for example, azlactone, epoxy, acid anhydrides, and the like.

The hydrophilic polymers can be synthesized in a manner known per se, from the corresponding monomers (the term monomer here also including a macromer) by a polymerization reaction customary to the person skilled in the art. For example, in one embodiment, the hydrophilic polymers can be preformed by at least (a) mixing the one or more monomers together; (b) adding a polymerization initiator; (c) subjecting the monomer/initiator mixture to a source of ultraviolet or actinic radiation and curing said mixture. Typical polymerization initiators include free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobis-isobutyronitrile (AIBN). Ultraviolet free-radical initiators illustrated by diethoxyacetophenone can also be used. The curing process will of course depend upon the initiator used and the physical characteristics of the comonomer mixture such as viscosity. In any event, the level of initiator employed will vary within the range of about 0.01 to about 2 weight percent of the mixture of monomers. Usually, a mixture of the above-mentioned monomers is warmed with addition of a free-radical former.

Polymerization of the monomeric mixture to form the hydrophilic polymer can be carried out in the presence of a solvent. Suitable solvents are in principle all solvents which dissolve the monomeric mixture used such as, for example, water, alcohols such as lower alkanols, e.g., methanol, methanol and the like; carboxamides such as dimethylformamide and the like; dipolar aprotic solvents such as dimethyl sulfoxide and the like; ketones such as acetone, methyl ethyl ketone, cyclohexanone, and the like; hydrocarbons such as toluene, xylene, n-hexane and the like; ethers such as THF, dimethoxyethane, dioxane and the like; halogenated hydrocarbons such astrichloroethane and the like, and also mixtures of suitable solvents, for example mixtures of water and an alcohol, e.g., a water/methanol or water/ethanol mixture, and the like.

Preferably the hydrophilic polymers comprise about 1 to about 100 mole percent of reactive monomeric units, more preferably about 5 to about 80 mole percent, most preferably about 30 to about 70 mole percent. The polymers may comprise 0 to about 99 mole percent of non-reactive hydrophilic monomeric units, and preferably about 50 to about 95 mole percent, more preferably about 60 to about 90 mole percent (the reactive monomers, once reacted may also be hydrophilic, but are by definition mutually exclusive with the monomers referred to as hydrophilic monomers which are non-reactive). Other monomeric units which are hydrophobic optionally may also be used in amounts up to about 35 mole percent, preferably 0 to 20 mole percent, most preferably 0 to 10 mole percent. Examples of hydrophobic monomers are functionalized silicones, functionalized fluorosilicones, functionalized perfluoroalkylethers, alkyl methacrylate, fluorinated alkyl methacrylates, long-chain acrylamides such as octyl acrylamide, and the like.

The hydrophilic gradient surface can be formed on the biomedical device by conventional techniques, for example, plasma polymerization, immersion, dip coating, spray coating, electrostatic coating and the like. For example, in one embodiment, a surface of a biomedical device can be exposed via plasma polymerization to a first monomeric mixture containing at least a first monomer in a gaseous state capable of forming a first layer and then sequentially exposing via plasma polymerization to a second and third monomeric mixture each containing at least a respective second and third monomer in a gaseous state capable of forming the second and third layers. If desired, one or more monomeric mixtures can be employed in each layer forming step.

Alternatively, a biomedical device can be immersed in a solution containing the hydrophilic polymers. Mixtures of hydrophilic polymers may be employed. For example, the hydrophilic polymer chains attached to the carbonaceous layer may be the result of the reaction of a mixture of polymers comprising (a) a first hydrophilic polymer having reactive functionalities in monomeric units along the hydrophilic polymers complementary to reactive functionalities on the carbonaceous layer and, in addition, (b) a second hydrophilic polymer having supplemental reactive functionalities that are reactive with the first hydrophilic polymer. For example, a contact lens may be placed or dipped for a suitable period of time in a solution of the hydrophilic polymer, copolymer or terpolymer in a suitable medium, for example, an aprotic solvent such as acetonitrile, to form each respective layer.

Subsequent to surface treatment, the lens may be subjected to extraction to remove residuals in the lenses. Generally, in the manufacture of contact lenses, some of the monomer mix is not fully polymerized. The incompletely polymerized material from the polymerization process may affect optical clarity or may be uncomfortable to the eye. Residual material may include solvents not entirely removed by the previous solvent removal operation, unreacted monomers from the monomeric mixture, oligomers present as by-products from the polymerization process, or even additives that may have migrated from the mold used to form the lens.

Conventional methods to extract such residual materials from the polymerized contact lens material include extraction with an alcohol solution for a few minutes up to several hours (for extraction of residual monomeric material) followed by hydration with water (and extraction of the residual alcohol solvent solution). Thus, any of the alcohol extraction solution which remains in the polymeric network of the polymerized contact lens material, should be extracted from the lens material before the lens may be worn safely and comfortably on the eye. Extraction of the alcohol from the lens can be achieved by employing heat and/or water for a few minutes up to several hours. Extraction should be as complete as possible, since incomplete extraction of residual material from lenses may contribute adversely to the useful life or comfort of the lens. Also, such residuals may impact lens performance and comfort by interfering with optical clarity or the desired uniform hydrophilicity of the lens surface. It is important that the selected extraction solution in no way adversely affects the optical clarity of the lens. Optical clarity is subjectively understood to be the level of clarity observed when the lens is visually inspected.

Subsequent to extraction, the lens can be subjected to hydration in which the lens is fully hydrated with water, buffered saline, or the like. When the lens is ultimately fully hydrated (wherein the lens typically may expand by about 10 to about 20 percent or more), the coating remains intact and bound to the lens, providing a durable, hydrophilic coating which has been found to be resistant to delamination.

Following hydration, the lens may undergo cosmetic inspection wherein trained inspectors inspect the contact lenses for clarity and the absence of defects such as holes, particles, bubbles, nicks, tears. Inspection is preferably at 10× magnification. After the lens has passed the steps of cosmetic inspection, the lens is ready for packaging, whether in a vial, plastic blister package, or other container for maintaining the lens in a sterile condition for the consumer. Finally, the packaged lens is subjected to sterilization, which sterilization may be accomplished in a conventional autoclave, preferably under an air pressurization sterilization cycle, sometime referred to as an air-steam mixture cycle, as will be appreciated by the skilled artisan. Preferably the autoclaving is at about 100° C. to about 200° C. for a period of about 10 to about 120 minutes. Following sterilization, the lens dimension of the sterilized lenses may be checked prior to storage.

Objects and advantages of this invention are further illustrated by the following examples, but the particular materials and amounts thereof recited in these examples, as well as other conditions and details should not be construed as unduly limiting this invention.

### EXAMPLE 1

Table 1 below represents a silicone hydrogel formulation which may be used as a coating substrate.

TABLE 1

| Component | Parts by Weight |
|---|---|
| TRIS-VC | 55 |
| NVP | 30 |
| V₂D₂₅ | 15 |
| VINAL | 1 |
| n-nonanol | 15 |
| Darocur | 0.2 |
| Tint agent | 0.05 |

The following materials are designated above:

| | |
|---|---|
| TRIS-VC | tris(trimethylsiloxy)silylpropyl vinyl carbamate |
| NVP | N-vinyl pyrrolidone |
| V₂D₂₅ | a silicone-containing vinyl carbonate as previously |
| | described in U.S. Pat. No. 5,534,604. |
| VINAL | N-vinyloxycarbonyl alanine |
| Darocur | Darocur-1173, a UV initiator |
| tint agent | 1,4-bis[4-(2-methacryloxyethyl)phenylamino] |
| | Anthraquinone |

Employing this material, a typical process for preparing a contact lens prior to its surface modification according to the present invention is as follows. Silicone hydrogel lenses made of the above formulation were cast-molded from polypropylene molds. Under an inert nitrogen atmosphere, 45-μl of the formulation was injected onto a clean polypropylene concave mold half and covered with the complementary polypropylene convex mold half. The mold halves were compressed at a pressure of 70 psi, and the mixture was cured for about 15 minutes in the presence of UV light (6-11 mW/cm²as measured by a Spectronic UV meter). The mold was exposed to UV light for about 5 additional minutes. The top mold half was removed and the lenses were maintained at 60° C. for 3 hours in a forced air oven to remove n-nonanol. Subsequently, the lens edges were ball buffed for 10 seconds at 2300 rpm with a force of 60 g.

### EXAMPLE 2

Table 2 below represents a polyurethane silicone hydrogel formulation which may be used as a coating substrate.

TABLE 2

| Component | Parts by Weight | |
|---|---|---|
| Urethane crosslinking resin | 55 | |
| TRIS | 20 | |
| DMA | 25 | |
| UV Absorber | 0.5 | |
| n-hexanol | 12 | |
| Irgacure-819 | 0.5 | |
| IMVT | 150 | ppm |

The following materials are designated above:

| | |
|---|---|
| TRIS | tris(trimethylsiloxy)silyipropyl methacrylate |
| DMA | N,N-dimethylacrylamide |
| Urethane | a silicone-containing crosslinking resin as |
| | previously described in U.S. Pat. No. 5,034,461. |
| Irgacure-819 | a UV initiator |
| IMVT | a tint agent, namely 1,4-bis[4-(2- |
| | methacryloxyethyl)phenylamino]anthraquinone |

### EXAMPLE 3

Table 3 below represents a polyfumarate silicone hydrogel formulation which may be used as a coating substrate.

TABLE 3

| Component | Parts by Weight | |
|---|---|---|
| F₂D₂₀ | 20 | |
| TRIS | 40 | |
| DMA | 40 | |
| n-hexanol | 5 | |
| Darocure-1173 | 0.5 | |
| IMVT | 150 | ppm |

The following materials are designated above:

| | |
|---|---|
| TRIS | tris(trimethylsiloxy)silyipropyl methacrylate |
| DMA | N,N-dimethylacrylamide |
| F₂D₂₀ | a silicone-containing crosslinking resin as previously |
| | described in U.S. Pat. Nos. 5,374,662 and 5,496,871 |
| Darocur | a UV initiator |
| IMVT | a tint agent, namely 1,4-bis[4-(2-methacryloxyethyl) |
| | phenylanimo] Anthraquinone |

### EXAMPLE 4

A substrate such as one obtained in each of Examples 1-3 is removed from a hydrophobic mold imparting hydrophobic character to the dry, molded device and any excess monomer may be removed from the device by any known method of extraction. A first coating is then applied on the device using a butadiene gas plasma for any desirable amount of time at the appropriate plasma power condition so as to impart a polybutadiene like carbonaceous coating on the surface of the device. Next, a second more hydrophilic surface character may be imparted by use of a propylene oxide gas plasma for any desirable amount of time at the appropriate plasma power condition so as to impart a polypropylene oxide like coating that is more hydrophilic than the first layer coating. A third even more hydrophilic surface character may then be imparted by use of an ethylene oxide gas plasma for any desirable amount of time at the appropriate plasma power condition so as to impart a polyethylene oxide like coating that is more hydrophilic than the second coating layer. Additional layers can likewise be added at any stage such that a gradient of hydrophilicity is formed and maintained from a main hydrophobic cast surface toward the more hydrophilic outer surface.

By increasing the oxygenation of the monomeric unit from the first to the second layer, the reactively formed polymer layer generally becomes more hydrophilic. By decreasing the length of carbon atoms in the monomer unit from the second layer to the third thus increasing the oxygen to carbon ratio, the reactively formed polymer generally becomes more hydrophilic.

The method described in this example to achieve a multilayer, gradient hydrophilicity coating is by plasma polymerization. It should be readily seen by one skilled in the art of plasma processes that by using gases comprised of these monomer chain units, a polymer can be formed via the aforementioned plasma polymerization process. Hence, working from the top outermost surface layer: an ethylene oxide gas can be used in a plasma polymerization process to form a poly(ethylene oxide) via a free radical initiation using the charged plasma ion environment. Likewise, a sublayer to the poly(ethylene oxide) layer can be made from a propylene oxide gas to form a poly(propylene oxide) layer, and a sublayer to this layer could be made from butadiene gas to form a poly(butadiene). Correspondingly, the intermediate layers of varying monomer gases may have interfacial layers wherein two gases can be applied sequentially. If applied simultaneously, a copolymer, terpolymer or other higher ordered multiphase polymers can be formed.

### EXAMPLE 5

A substrate such as one obtained in each of Examples 1-3 is removed from a hydrophobic mold imparting hydrophobic character to the dry, molded device and any excess monomer may be removed from the device by any known method of extraction. The device may then have a surface activation be initiated by any known surface activation method (e.g., plasma, tie layers, in-monomer reactive units, etc.) so as to have reactive surface sites available for the subsequent gradient surface coating. A first coating such as an end functionalized polybutadiene is then applied on the device, using any coating process available such as solution coating, spray coating or the like, to yield a carbonaceous coating. A second more hydrophilic surface character may then be imparted by use of an end functionalized polypropylene oxide, using any coating process available such as solution coating, spray coating or the like to yield a second layer coating that is more hydrophilic than the first layer coating. Next, a third even more hydrophilic surface character may be imparted by use of an end functionalized polyethylene oxide, using any coating process available such as solution coating, spray coating or the like, to yield a coating that is more hydrophilic than the second layer coating. Additional layers can likewise be added at any stage such that the hydrophilic gradient is formed and maintained from a main hydrophobic cast surface toward the more hydrophilic outer surface.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A biomedical device having a hydrophilic gradient surface, wherein the hydrophilic gradient surface comprises (a) a first layer having a first contact angle; (b) a second layer having a second contact angle, the second contact angle being less than the first contact angle of the first layer; and (c) a third layer having a third contact angle, the third contact angle being less than the first and second contact angles of the first and second layers.

2. The biomedical device of claim 1, wherein the first contact angle of the first layer is at least about 100 degrees as measured by the sessile drop method in a hydrophilic liquid.

3. The biomedical device of claim 1, wherein the first contact angle of the first layer is at least about 100 degrees; (b) the second contact angle of the second layer is at least about 70 degrees; and (c) the third contact angle of the third layer is no greater than about 69 degrees, wherein the contact angle of each layer is measured by the sessile drop method in a hydrophilic liquid.

4. The biomedical device of claim 1, wherein the first contact angle of the first layer is no greater than about 120 degrees; (b) the second contact angle of the second layer is from about 70 to about 99 degrees; and (c) the third contact angle of the third layer is no greater than about 69 degrees, wherein the contact angle of each layer is measured by the sessile drop method in a hydrophilic liquid.

5. The biomedical device of claims 1-4, wherein the contact angle of each respective layer is determined with a sessile drop of deionized water.

6. The biomedical device of claims 1-5, wherein the first layer is a carbonaceous layer, and the second and third layers comprise one or more hydrophilic polymers.

7. The biomedical device of claims 1-5, wherein the first layer is a carbonaceous layer, the second layer comprises a first hydrophilic polymer having chains attached to the carbonaceous layer wherein the points of attachment are the result of the reaction of complementary reactive functionalities in monomeric units along the hydrophilic polymer with reactive functionalities on the carbonaceous layer, and the third layer comprises a second hydrophilic polymer.

8. The biomedical device of claims 1-5, wherein the first layer is a poly(butadiene) and the second and third layers comprise a hydrophilic polymer, copolymer or terpolymer comprising one or more alkylene oxide units.

9. The biomedical device of claims 1-5, wherein the first layer is a poly(butadiene) and the second and third layers comprise a hydrophilic polymer, copolymer or terpolymer comprising one or more C₁-C₄ alkylene oxide units.

10. The biomedical device of claims 1-5, wherein the first layer comprises a poly(butadiene), the second layer comprises a hydrophilic polymer, copolymer or terpolymer comprising one or more butylene oxide units and/or propylene oxide units and the third layer comprises a hydrophilic polymer, copolymer or terpolymer comprising one or more ethylene oxide units.

11. The biomedical device of claims 1-5, wherein the first, second and third layers comprises a hydrophilic polymer.

12. The biomedical device of claims 1-5, wherein the first, second and third layers comprises a hydrophilic polymer, copolymer or terpolymer comprising one or more alkylene oxide units.

13. The biomedical device of claims 1-5, wherein the first layer comprises a hydrophilic polymer, copolymer or terpolymer comprising one or more butylene oxide units, the second layer comprises a hydrophilic polymer, copolymer or terpolymer comprising one or more propylene oxide units and the third layer comprises a hydrophilic polymer, copolymer or terpolymer comprising one or more ethylene oxide units.

14. The biomedical device of claims 1-5, wherein the first layer comprises a poly(butylene) oxide, the second layer comprises a poly(propylene) oxide, and the third layer comprises a poly(ethylene) oxide.

15. The biomedical device of claims 6, 7 and 11, wherein the hydrophilic polymers are obtained from the polymerization of a monomeric mixture comprising one or more hydrophilic monomers.

16. The biomedical device of claim 15, wherein the monomeric mixture further comprises one or more hydrophobic monomers.

17. The biomedical device of claims 15 and 16, wherein the hydrophilic monomers are selected from the group consisting of amines, acrylamides, lactams, alkylene oxides, methacrylic acid and hydroxyalkyl methacrylates.

18. The biomedical device of claims 1-5, wherein the second and third layers comprise one or more hydrophilic polymers.

19. The biomedical device of claims 1-18, which is a silicone hydrogel, continuous-wear contact lens.

20. A method for increasing hydrophilicity or wettability of a biomedical device having a hydrophilic gradient surface, the method comprising applying to the surface of the biomedical device a hydrophilic gradient coating comprising (a) a first layer having a first contact angle; (b) a second layer having a second contact angle, the second contact angle being less than the first contact angle of the first layer; and (c) a third layer having a third contact angle, the third contact angle being less than the first and second contact angles of the first and second layers.

21. The method of claim 20, wherein the first contact angle of the first layer is at least about 100 degrees as measured by the sessile drop method in a hydrophilic liquid.

22. The method of claim 20, wherein the first contact angle of the first layer is at least about 100 degrees; (b) the second contact angle of the second layer is at least about 70 degrees; and (c) the third contact angle of the third layer is no greater than about 69 degrees, wherein the contact angle of each layer is measured by the sessile drop method in a hydrophilic liquid.

23. The method of claim 20, wherein the first contact angle of the first layer is no greater than about 120 degrees; (b) the second contact angle of the second layer is from about 70 to about 99 degrees; and (c) the third contact angle of the third layer is no greater than about 69 degrees, wherein the contact angle of each layer is measured by the sessile drop method in a hydrophilic liquid.

24. The method of claims 20-23, wherein the contact angle of each respective layer is determined with a sessile drop of deionized water.

25. The method of claims 20-24, wherein the first layer is a carbonaceous layer, and the second and third layers comprise one or more hydrophilic polymers.

26. The method of claims 20-24, wherein the first layer is a carbonaceous layer, the second layer comprises a first hydrophilic polymer having chains attached to the carbonaceous layer wherein the points of attachment are the result of the reaction of complementary reactive functionalities in monomeric units along the hydrophilic polymer with reactive functionalities on the carbonaceous layer, and the third layer comprises a second hydrophilic polymer.

27. The method of claims 20-24, wherein the first layer is a poly(butadiene) and the second and third layers comprise a hydrophilic polymer, copolymer or terpolymer comprising one or more alkylene oxide units.

28. The method of claims 20-24, wherein the first layer is a poly(butadiene) and the second and third layers comprise a hydrophilic polymer, copolymer or terpolymer comprising one or more C₁-C₄ alkylene oxide units.

29. The method of claims 20-24, wherein the first layer comprises a poly(butadiene), the second layer comprises a hydrophilic polymer, copolymer or terpolymer comprising one or more butylene oxide units and/or propylene oxide units and the third layer comprises a hydrophilic polymer, copolymer or terpolymer comprising one or more ethylene oxide units.

30. The method of claims 20-24, wherein the first, second and third layers comprises a hydrophilic polymer.

31. The method of claims 20-24, wherein the first, second and third layers comprises a hydrophilic polymer, copolymer or terpolymer comprising one or more alkylene oxide units.

32. The method of claims 20-24, wherein the first layer comprises a hydrophilic polymer, copolymer or terpolymer comprising one or more butylene oxide units, the second layer comprises a hydrophilic polymer, copolymer or terpolymer comprising one or more propylene oxide units and the third layer comprises a hydrophilic polymer, copolymer or terpolymer comprising one or more ethylene oxide units.

33. The method of claims 20-24, further comprising pretreating the surface of the device with a carbonaceous layer and wherein the first layer of the hydrophilic gradient comprises a hydrophilic polymer, copolymer or terpolymer comprising one or more butylene oxide units, the second layer comprises a hydrophilic polymer, copolymer or terpolymer comprising one or more propylene oxide units; and the third layer comprises a hydrophilic polymer, copolymer or terpolymer comprising one or more ethylene oxide units.

34. The method of claims 25, 26 and 30, wherein the hydrophilic polymers are obtained from the polymerization of a monomeric mixture comprising one or more hydrophilic monomers.

35. The method of claim 34, wherein the monomeric mixture further comprises one or more hydrophobic monomers.

36. The method of claims 34 and 35, wherein the hydrophilic monomers are selected from the group consisting of amines, acrylamides, lactams, alkylene oxides, methacrylic acid and hydroxyalkyl methacrylates.

37. The method of claims 20-24, wherein the second and third layers comprise one or more hydrophilic polymers.

38. The method of claims 20-37, wherein the biomedical device is a silicone hydrogel, continuous-wear contact lens.
